(19) United States
(12) Patent Application Publication
(10) Pub. No.: US 2025/0297925 A1
(43) Pub. Date: Sep. 25, 2025

(54) SAMPLING DRILL FOR LOW GRAVITY ENVIRONMENTS

(71) Applicant: Honeybee Robotics, LLC, Longmont, CO (US)

(72) Inventors: Nicklaus Traeden, Cuyahoga Falls, OH (US); Kathryn Faye Bywaters, Monrovia, CA (US); Kris Zacny, Altadena, CA (US); Peter Pulai, Los Angeles, CA (US)

(21) Appl. No.: 19/082,529

(22) Filed: Mar. 18, 2025

Related U.S. Application Data
(60) Provisional application No. 63/567,723, filed on Mar. 20, 2024.
(60) Provisional application No. 63/571,621, filed on Mar. 29, 2024.

(51) Int. Cl. G01N 1/08; E21B 6/04

(52) U.S. Cl. CPC G01N 1/08; E21B 6/04

(57) ABSTRACT

A drill, system, and method is provided. The drill includes a translation mechanism and an auger mechanism. The auger mechanism is movably coupled to the translation mechanism, the drill mechanism having a housing with an auger bit slidably disposed therein, the auger mechanism further having a collection housing coupled to one end, the auger bit being configured to extend through the collection housing during operation, the collection housing having a hollow interior.

### BACKGROUND OF THE DISCLOSURE

The subject matter disclosed herein relates to a drilling system for collecting a sample, and in particular for obtaining a low mass sample from a target object.

Drills for obtaining samples typically utilize a separate rotation and percussion actuator. These drills utilize coring drills that have an axial hole that collects the sample. The drill bit is placed against the surface of the target object and the user applies force to cause the drill to translate into the object. As the drill travels into the object, material is forced into the axial hole. Once the drilling is completed, the user can withdraw the drill bit and obtain the sample material from the axial hole.

Existing drill systems are suitable for their intended purposes but the need for improvement remains, particularly in providing a drill system having the features described herein.

### BRIEF DESCRIPTION OF THE DISCLOSURE

According to one aspect of the disclosure a drill is provided. The drill includes a translation mechanism and an auger mechanism. The auger mechanism is movably coupled to the translation mechanism, the drill mechanism having a housing with an auger bit slidably disposed therein, the auger mechanism further having a collection housing coupled to one end, the auger bit being configured to extend through the collection housing during operation, the collection housing having a hollow interior.

In addition to one or more of the features described herein, or as an alternative, further embodiments of the drill may include the collection housing being configured to receive material from the auger bit during operation.

In addition to one or more of the features described herein, or as an alternative, further embodiments of the drill may include the collection housing having a conical portion.

In addition to one or more of the features described herein, or as an alternative, further embodiments of the drill may include the auger bit being removably coupled to a drill shaft that is slidably coupled to a motor.

In addition to one or more of the features described herein, or as an alternative, further embodiments of the drill may include a first biasing member operably coupled between the housing and the drill shaft to bias the auger to extend outward from the collection housing.

In addition to one or more of the features described herein, or as an alternative, further embodiments of the drill may include a hammer assembly operably coupled between the housing and the motor, the hammer assembly configured to selectively oscillate the auger bit during operation.

In addition to one or more of the features described herein, or as an alternative, further embodiments of the drill may include the hammer assembly having a dog clutch and a second biasing member. The dog clutch having a first member coupled to the drill shaft and a second member operably coupled to the housing, the first member and second member being selectively coupled in response to axial translation of the auger bit. The second biasing member is operably coupled to the second member, the second biasing member cooperating with the first biasing member to oscillate the auger bit in response to the first member engaging the second member.

In addition to one or more of the features described herein, or as an alternative, further embodiments of the drill may include the second biasing member being a plurality of Belleville Springs.

In addition to one or more of the features described herein, or as an alternative, further embodiments of the drill may include the first biasing member being a compression spring.

In addition to one or more of the features described herein, or as an alternative, further embodiments of the drill may include the translation mechanism having a frame, a lead screw rotationally coupled to the frame, and a second motor operably coupled to the lead screw.

In addition to one or more of the features described herein, or as an alternative, further embodiments of the drill may include the drill mechanism having a lead nut coupled to the lead screw, the lead nut causing the drill mechanism to translate in response to rotation of the lead screw.

In addition to one or more of the features described herein, or as an alternative, further embodiments of the drill may include the translation mechanism having at least one slide member fixedly coupled to the frame, the housing being slidably coupled to the slide member.

According to another aspect of the disclosure, a system is provided. The system includes a sample collection device, a drill device and a controller. The sample collection device having a sample container. The drill device includes a translation mechanism and an auger mechanism movably coupled to the translation mechanism, the auger mechanism having a housing with an auger bit slidably disposed therein, the auger mechanism further having an collection housing coupled to one end, the auger bit being configured to extend through the collection housing during operation, the collection housing having a hollow interior. The controller is operably coupled to the sample collection device and the drill device.

In addition to one or more of the features described herein, or as an alternative, further embodiments of the system may include the controller being operable to selectively actuate the translation mechanism to translate the auger mechanism.

In addition to one or more of the features described herein, or as an alternative, further embodiments of the system may include the controller being operably to selectively actuate the auger mechanism to rotate the auger bit in a first direction prior to the auger bit contacting a target surface.

In addition to one or more of the features described herein, or as an alternative, further embodiments of the system may include the auger mechanism being configured to oscillate the auger bit in response to the translation mechanism generating a predetermined amount of preload on the auger bit.

In addition to one or more of the features described herein, or as an alternative, further embodiments of the system may include the controller being further operable to cause the translation mechanism to translate the auger bit away from a target surface and transfer sample material from the collection housing to the sample container.

In addition to one or more of the features described herein, or as an alternative, further embodiments of the system may include the transferring of sample material from the collection housing to the sample container includes the controller causing the auger bit to rotate in a second direction when the auger bit is positioned in the sample container, the second direction being opposite the first direction.

According to another aspect of the disclosure, a method of collecting and analyzing a sample is provided. The method includes providing a drilling assembly having a linear stage and an auger mechanism. Rotation is initiated in a first direction of an auger bit in the auger mechanism. The linear stage is moved to cause the auger bit to move in a direction towards a target surface on a target object. The auger bit engages with the target surface. A percussion impact is caused with the auger mechanism in respect to the auger bit engaging the target surface. Material from the target object is caused to enter a flute on the auger bit and move into a collection housing on the auger mechanism. The material is caused to move from the flute into a space within the collection housing.

In addition to one or more of the features described herein, or as an alternative, further embodiments of the method may include moving the linear stage to remove the auger bit from a hole. The auger bit is rotated in a second direction, the second direction being opposite the first direction. A percussion impact is caused with the auger mechanism. Sample material is dispensed from the collection housing.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 depicts a perspective view of a drill assembly in accordance with an embodiment;

FIG. 2A depicts a partial sectional view of the drill of FIG. 1 in accordance with an embodiment;

FIG. 2B is an enlarged partial sectional view of the drill of FIG. 2A in a first position with no preload in accordance with an embodiment;

FIG. 2C is an enlarged partial sectional view of the drill of FIG. 2A in a second position with the hammer assembly clutch engaged in accordance with an embodiment;

FIG. 2D is a partial perspective sectional view of the drill of FIG. 2A in accordance with an embodiment;

FIG. 2E is an enlarged partial perspective sectional view illustrating a portion of a dog clutch for use with the drill of FIG. 2A;

FIG. 2F is a partial side view of the drill of FIG. 2A with a collection housing having openings to limit the amount of sample collected;

FIG. 2G is a side view of the collection housing of FIG. 2F;

FIG. 3A is a partial side view of a collection housing portion of an auger mechanism for the fill of FIG. 2A illustrating the engagement of an auger bit with a target surface of a target object in accordance with an embodiment;

FIG. 3B is a partial side view of the collection housing portion of FIG. 3A illustrating the flow of sample material from a drilled hole in the target object into the collection housing;

FIG. 4A is a side view of an optional linkage assembly for facilitating removal of the sample in a first or sample collection position in accordance with an embodiment;

FIG. 4B is a side view of an optional linkage assembly for facilitating removal of the sample in a second or dispensing position in accordance with an embodiment;

FIG. 4C is a partial side sectional view of the drill of FIG. 2A that cooperates with the linkage assembly of FIG. 3B for dispensing the sample in accordance with an embodiment;

FIG. 5 is a schematic view of a system for collecting samples in accordance with an embodiment;

FIG. 6 is a flow diagram of a method of obtaining a sample using the drill assembly of FIG. 1 in accordance with an embodiment; and

FIG. 7 is a flow diagram of a method of obtaining an acquired sample from the drill assembly of FIG. 1 in accordance with an embodiment.

The detailed description explains embodiments of the disclosure, together with advantages and features, by way of example with reference to the drawings.

### DETAILED DESCRIPTION OF THE DISCLOSURE

A disadvantage of the planetary drilling systems employed on the Apollo missions is the limited drilling capability, only coring samples up to three meters below an extraterrestrial surface. These systems are also not configured to operate in a vacuum, which then involves the pressurization of some portions of the system with nitrogen. As the number of scientific and commercial extraterrestrial endeavors increases, systems are needed that provide additional testing and collecting capabilities.

Commonly used systems were designed for extracting core samples from the environment being tested. These core samples are large (˜1 inch, 2.53 cm) in diameter. Further, when X-ray diffraction techniques are desired, the core sample needed further processing to obtain the material in a form (e.g. powdered) that was suitable for the intended analysis technique. As a result, these systems tended to be larger, more complex and bulky to handle. Accordingly, while existing planetary drilling systems are suitable for their intended purposes the need for improvement remains, particularly in providing a drill having the features described herein.

Embodiments of the present disclosure provide for a drill based sampling device that is configured to acquire material samples from a shallow depth beneath a surface. Further embodiments of the present disclosure provide for a simplified percussion assembly to improve drilling operations. And further embodiments of the present disclosure provide for a drill operable to provide a predetermined amount of sample to an analysis system in a desired form.

Embodiments provide for a rotary-percussive drill. Weight On Bit (WOB) is generated by loading the drill bit into a rock using a z-stage of the drill. An internal percussion dog clutch system is activated once there is enough WOB generated to compress an internal biasing member. This percussion provides advantages in generating a kinetic impact that travels down the drill string to break up the rock during drilling. A powder funnel collection system preloads against the cuttings pile generated during drilling to contain a precise amount of sample. In an embodiment, the sample powder is released from the funnel by employing a four-bar mechanism actuated by the z-stage. In some embodiments, the rotary-percussive drill is intended to be used on an end effector that can preload into the drill surface to counteract the WOB loads.

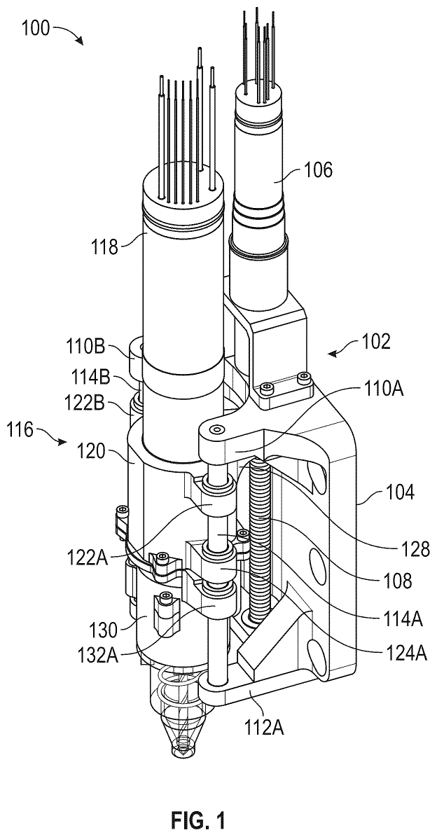

Referring now to FIG. 1, an embodiment is shown of a drill assembly 100. It should be appreciated that while embodiments herein may refer to the use of the drill assembly 100 with respect to a particular application, such collection of a sample from an extraterrestrial location, such as the Moon or lunar surface, this is for example purposes and the claims should not be so limited. In other embodiments, the drill assembly 100 described herein may be used in connection with sample collection from other terrestrial or extraterrestrial bodies, such as but not limited to Mars, asteroids, Kuiper Belt objects, and Trans-Neptunian objects for example. In still further embodiments, the drill assembly 100 may be used on moons/satellite objects of other solar system planets, such as Titan or Europa for example.

The drill assembly 100 includes a linear stage 102 having a frame 104 with a motor 106 mounted thereon. In an embodiment, the motor 106 is a 28V DC motor. A lead screw 108 is coupled to the motor 106 on a first end and is rotationally coupled to a flange on the end of the frame 104. When the motor 106 is activated, the lead screw 108 rotates on the frame 104. The frame 104 includes a first pair of arms 110A, 110B and a second pair of arms 112A, 112B. Extending between the pairs of arms 110A, 110B, 112A, 112B are a two slide members 114A, 114B.

The drill assembly 100 further includes an auger assembly 116 having a motor 118 coupled to a mount housing 120. In an embodiment, the motor 118 is a 28V DC motor. The mount housing 120 includes a first pair of projections 122A, 122B and a second set of projections 124A, 124B that each have bearings 126 that couple the mount housing 120 to the slide members 114A, 114B respectively. The mount housing 120 further includes a flange 128 having a lead nut (not shown) that couples with the lead screw 108. It should be appreciated that the lead nut and lead screw 108 cooperate to slide the auger assembly 116 on the slide members 114A, 114B in response to activation of the motor 106.

The auger assembly further includes a percussion housing 130 that is movably coupled to the mount housing 120. The percussion housing 130 includes a pair of projections 132A, 132B that each include bearings 126 that slidably couple the percussion housing 130 to the slide members 114A, 114B. Extending from an end of the percussion housing 130 is a collection housing 134. As discussed in more detail herein, the collection housing 134 allows an auger bit to pass therethrough and is configured to receive sample material that is removed from a hole formed by the auger bit. In an embodiment, the percussion housing 130 is operably coupled to at least one activator arm 135 that extends past the end of the percussion housing and an end of the auger assembly. As will be discussed in more detail below, the activator arm 135 includes a projection that selectively engages a thrust plate 210 to activate the dog clutch. In the illustrated embodiment, two activator arms 135 are provided.

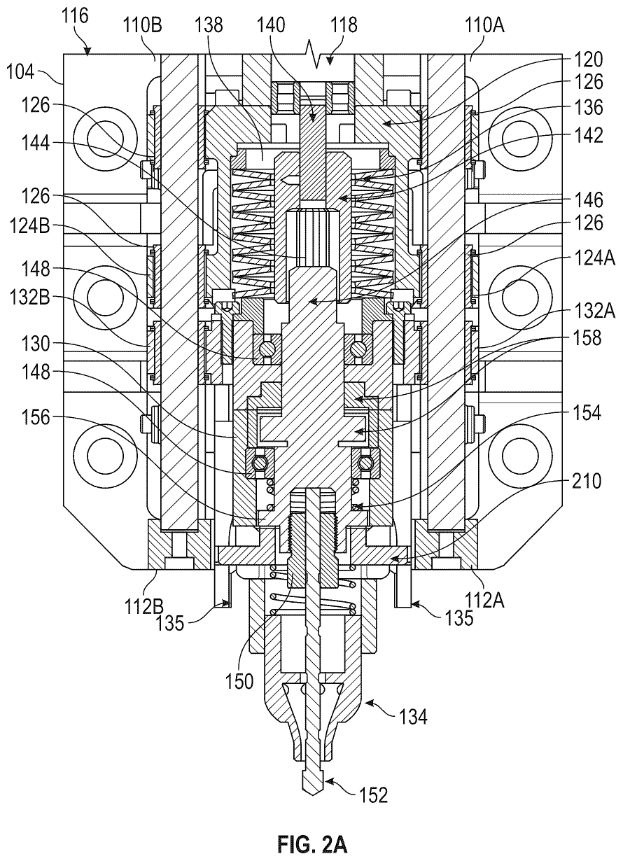

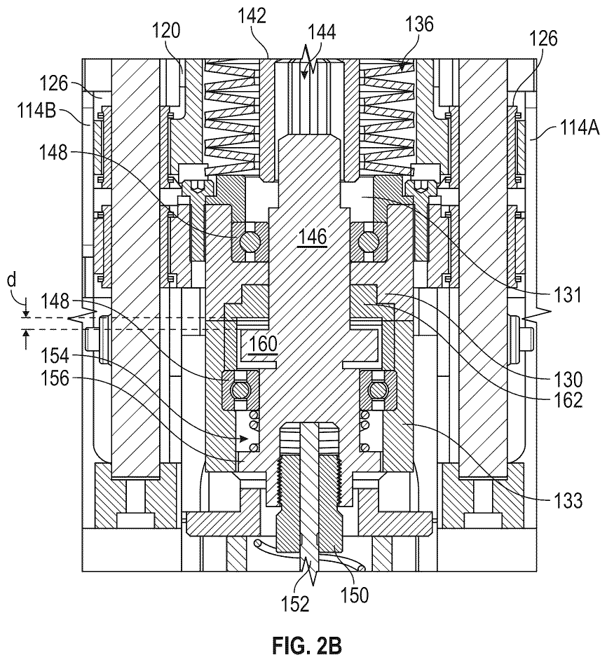

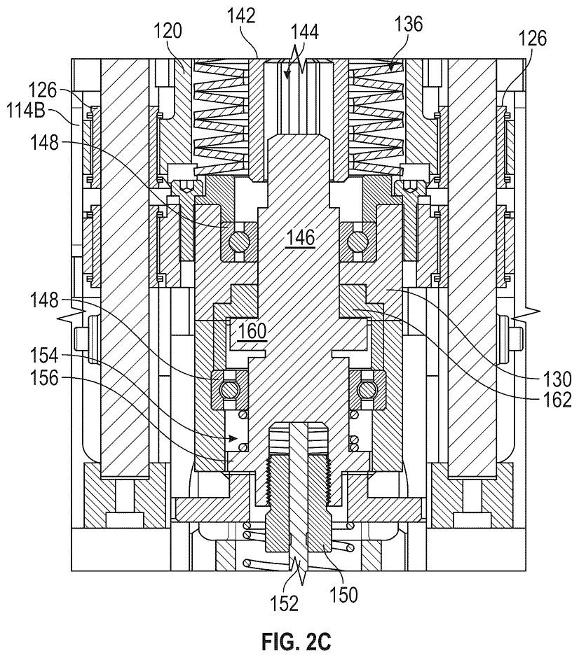

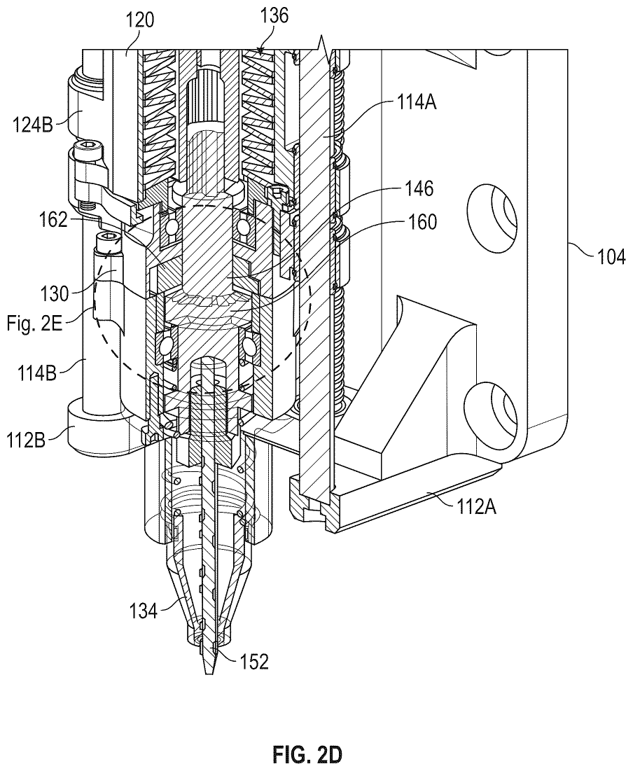

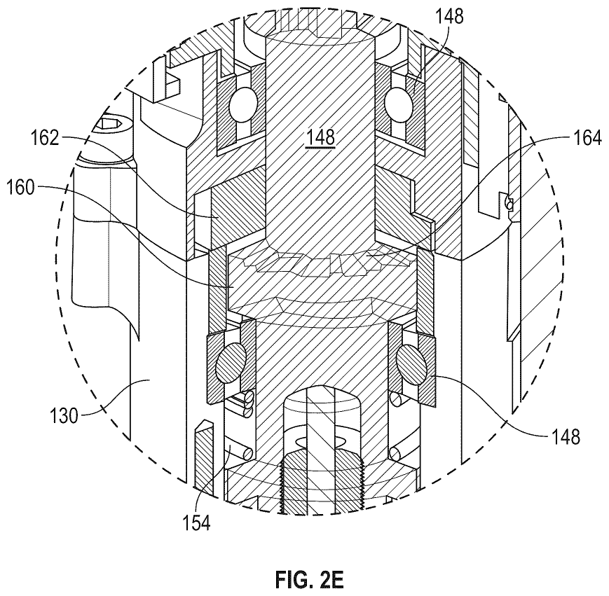

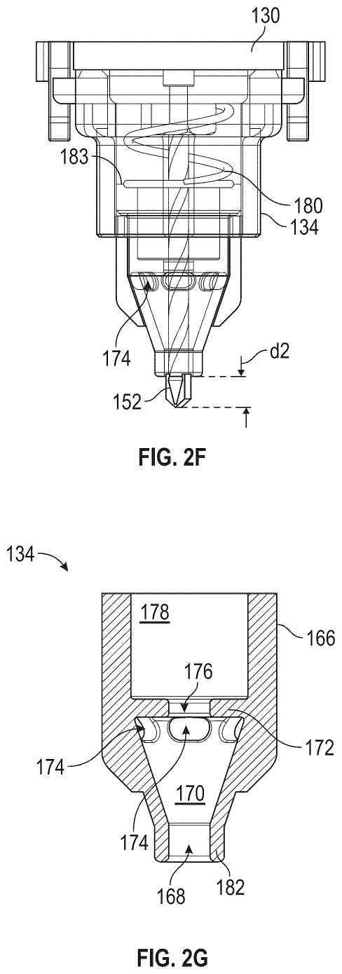

Referring now to FIG. 2A, an embodiment is shown of the auger assembly 116. In this embodiment, the motor 118 is fixedly coupled to the mount housing 120. The mount housing 120 includes a hollow interior that is sized to receive a biasing member 136, such as a plurality of spring or Bellville washers for example. The biasing member 136 is spaced apart from the end surface of the hollow interior by a spacer 138. The spacer 138 is configured to be replaceable to allow changing of the preload on the percussion housing 130.

The motor 118 includes an output shaft 140 that connects to a coupler 142. The coupler 142 includes an internal passage 144 having a first portion on a first end that fixedly couples to the output shaft 140. The internal passage 144 further includes a second portion on an opposing second end that is slidable coupled to a drill shaft 146. In an embodiment, the drill shaft includes splines that engage slots in the internal passage 144 to allow transmission of torque from the motor 118 to the drive shaft 146.

The drill shaft 146 is coupled to the percussion housing 130 by a pair of bearings 148. An opposing end of the drive shaft 146 is a chuck 150 that is adapted to allow an auger bit 152 to be removably coupled thereto. In an embodiment, the auger bit 152 is a ⅛ inch (3 mm) diameter masonry-type bit. The auger bit 152 extends through the collection housing 134. A biasing member, such as compression spring 154 may be arranged between a wall 156 of the drill shaft 146 and an inner wall of the percussion housing 130 or the lower bearing 148. The compression spring 154 provides a biasing force that defines a desired amount of preload (WOB) before a dog clutch 158 is engaged.

Referring now to FIG. 2B-FIG. 2E with continuing reference to FIG. 2A. It should be appreciated that the percussion housing, along with the drill shaft 146, dog clutch 158, chuck 150, auger bit 152, and collection housing 134 are axially slidable relative to mount housing 120. Further, the drill shaft 146, chuck 150 and auger bit 152 are slidable relative to percussion housing 130. When in an unloaded operating state, such as where the force on the compression spring 154 is less than a predetermined preload for example, the dog clutch 158 will be disengaged as shown in FIG. 2B. In an embodiment, the dog clutch 158 is comprised of a rotating portion 160 and a stationary portion 162. The rotating portion 160 is fixedly coupled to the drill shaft 146 and the stationary portion 162 is fixedly coupled to an inner end wall the percussion housing 130. In the unloaded operating state of FIG. 2B, the rotating portion 160 and stationary portion 162 are separated by a distance “d”.

When the auger bit 152 is placed against a surface with a load that exceeds the predetermined preload (e.g. overcomes the spring force of spring 154), the drill shaft 146 will axially slide relative to the percussion housing 130, causing the dog clutch 158 to engage as shown in FIG. 2A and FIG. 2C. In the example embodiment, the load on the auger bit 152 is generated by activation of linear stage 102. The engagement of the dog clutch 158 generates contact forces that cause the stationary portion 162 and the entire assembly within the percussion housing 130 into and compress the biasing member 136 (e.g. Belleville springs). As discussed more below with respect to FIG. 2D and FIG. 2E, when the ramps in the dog clutch are cleared, the biasing member 136 releases pushing the percussion housing 130 providing a percussive impact through the auger bit into the surface being drilled. This movement causes the stationary portion 162 into the rotating portion 160 and the process repeats to generate a series of percussive impacts.

Referring now to FIG. 2D and FIG. 2E, an embodiment is shown of the rotating portion 160 of the dog clutch 158. In this embodiment, both rotating portion 160 and the stationary portion 162 have a plurality of ramps 164 (sometimes referred to as dog ramps or lobe teeth) that cooperate with each other as the rotating portion 160 rotates over the stationary portion 162. As the rotating portion 160 rotates the rotating ramp moves along or “up” the stationary ramp, causing the stationary portion 162 and the percussion housing 130 are moved axially to compress the biasing member 136. As the rotating ramp clears the peak of the stationary ramp, the stationary ramp axially moves back towards the rotating portion 160 to generate the percussive impact. In this embodiment, the dog clutch 158 includes a plurality of ramps, such as 12 or 16 ramps about the end surfaces of the rotating portion 160 and stationary portion 162. This impact travels down the drill string, through the drill bit, and into the surface being drilled. It should be appreciated that the application of percussive impacts provides advantages in facilitating the drilling of hard surfaces, such as rock. The percussion generated by the dog clutch continues during operation while the weight on bit remains at the threshold level. When the weight on bit falls below the threshold level, the dog clutches return to their unloaded state, thus enabling rotary only drilling.

In an embodiment, the percussor housing elements 130, 131, 133 and the upper dog clutch 162 form a percussive mass. The total energy per impact is dependent on the percussive mass, the Belleville stack 136 spring rate, and the total axial displacement induced from the dog clutch, which varies depending on rotary speed and WOB. The spring stack 136 may be selected to provide enough impact energy at 80% dog clutch height to break up 120 MPa ultimate compressive strength saddleback basalt. In an embodiment, dog-bone elements on the spring housing engage with a lip feature on the percussion housing and keep the Belleville springs 136 slightly preloaded. It was found that symmetrical lobes/ramps 174 provided increased functionality over a more standard sawtooth design for releasing the sample material.

Referring now to FIG. 2F and FIG. 2G, an embodiment is shown of the collection housing 134. It should be appreciated that in embodiments, it may be desirable to collect a predetermined amount of sample to avoid overloading the analysis equipment. For example, a typical X-ray diffraction apparatus uses a predetermined amount of sample. Providing additional amounts of the sample may interfere with the analysis process. In this embodiment, the collection housing 134 includes a body 166 having a centrally located entrance opening 168 that extends a predetermined amount into the body 166. The entrance opening 168 communicates with a frustoconically shaped interior space 170 that gets radially larger in a direction away from the entrance opening 168. The body 166 includes a wall 172 that defines an end surface of the interior space 170. A plurality of holes 174 extend through a side wall between the interior space 170 and an external environment. In an embodiment, the holes 174 have an oblong shape. The holes 174 are disposed about the periphery of the interior space 170 adjacent the wall 172. The wall 172 has an opening 176 that is axially aligned with the entrance opening 168. The openings 168, 176 are sized to allow the auger bit 152 to pass therethrough. The body 166 may include a second interior space 178 that is sized to receive an engagement or compression spring 180 that is positioned between the thrust plate 210 and a surface 183 of the collection housing 134. In an embodiment, counter rotation ribs may be provided on the body 166 to allow the collection housing 134 to translate but not catch on the spinning auger 152.

In an embodiment, the auger bit 152 extends a predetermined distance “d2” from an end 182 of the body 166. The distance d2 is fixed for a given operation depending on the depth that the operator wishes to obtain a sample. To advance the auger bit 152 into the surface, the linear stage 102 is activated to move the mounting housing towards the surface being drilled. In some environments, such as on the surface of Mars or on Lunar surfaces, there may be a surface layer (e.g. ˜2 mm of weathered rock) of material that is not desired for analysis. In these embodiments, the distance d2 will be extended to collect sample material from below the undesired surface layer. In an embodiment, unconsolidated material, such as sand or dust deposits may be collected without compressing the compression spring 180.

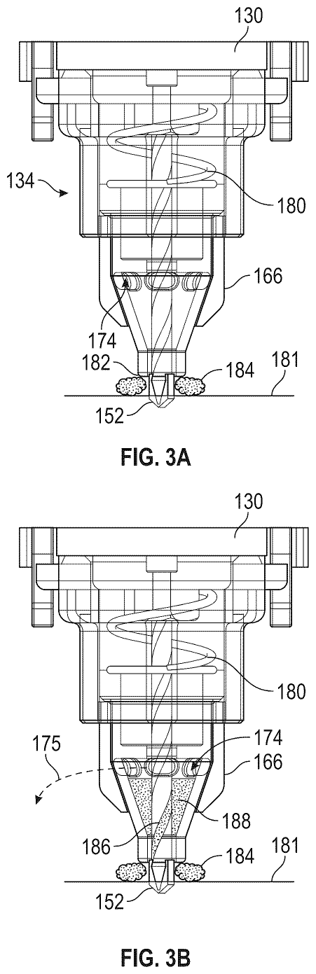

Referring now to FIG. 3A and FIG. 3B, in an embodiment, as a target surface 181 starts to be drilled, a pile of powder 184 will gather around and between the end 182 and the target surface 181. The powder 184 effectively extends the length of the hole being formed by the auger bit 152. As a result, as the auger bit 152 is advanced into the surface, the extracted sample material will travel up the flutes 186 of the auger bit 152, through the entrance opening 168 and into the interior space 170. Once in the interior space 170, the centripetal load on the sample material will cause the sample material to leave the flutes 186 and deposit 188 in the interior space 170 (FIG. 3B). Once the level of deposit 188 reaches the holes 174, the material will exit the body 166 via the holes 174 as indicated by the arrow 175 and no additional material will be collected. It should be appreciated that the interior volume 170 (below the holes 174) is sized to contain the desired amount of sample material for the analysis apparatus being used (e.g. X-ray diffraction).

Once the drilling operating is completed, it is desired to extract the sample material from the interior volume 170 for analysis or into a sample container. It has been found that operating the motor 118 in reverse will cause the sample material to be ejected from the entrance opening 168. It has also been found that the extraction of the sample material may be enhanced by operating the motor 118 in a reverse direction while also engaging the dog clutch 158 to provide a percussive impact. Without being constrained by theory, it is believed that the percussive impact during extraction acts to separate the sample material from the inside surfaces of the interior space 170.

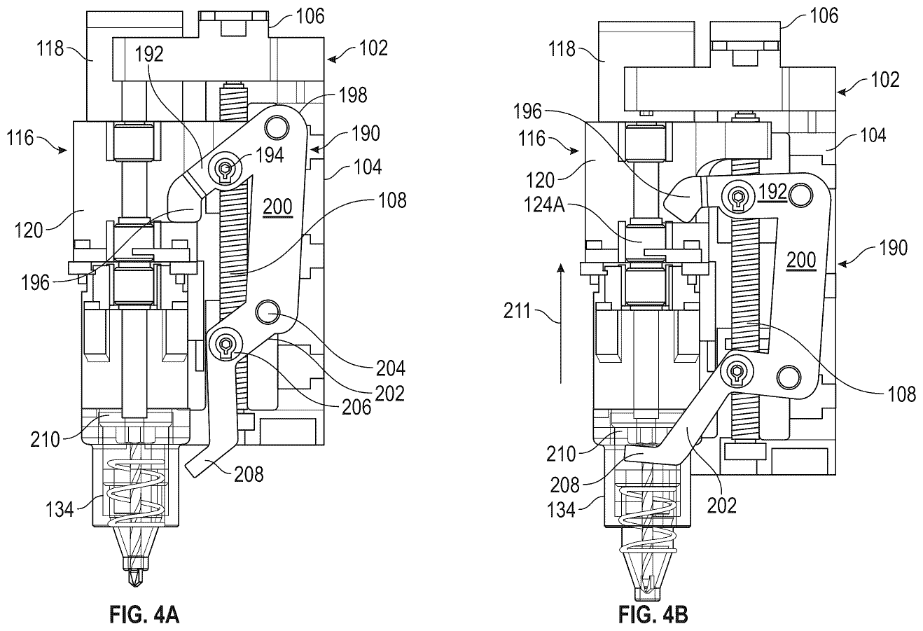

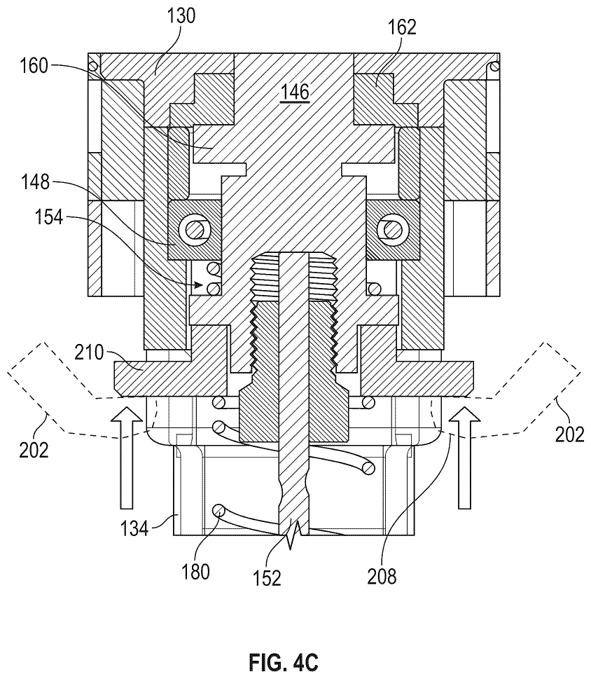

Referring now to FIG. 4A-4C, an embodiment is shown of a linkage assembly 190 that is coupled between the linear stage 102 and the auger assembly 116. In this embodiment, the linkage assembly 190 includes a four-bar linkage comprising a first link 192 that is coupled by a pivot 194 to the frame 104. The first link 192 includes an end 196 that engages a feature on the mount housing 120, such a surface on the projections 124A, 124B. Coupled by a pivot 198 to the first link 192 is a second link 200. The second link 200 connects with a third link 202 via a pivot 204. The third link 202 is pivotally coupled to the frame 104 by a pivot 206. In an embodiment, the third link 202 has an S-shape that positions an end 208 to selectively engage a thrust plate 210 in the auger assembly 116 based on the position of the auger mechanism relative to the lead screw 108. In an embodiment, the thrust plate 210 may also be engaged by activator arms 135 in response to the end of the activator arms contacting a surface.

When the auger assembly 116 is in a drill operating position (FIG. 4A), the end 208 is spaced apart from the thrust plate 210. Once drilling is concluded and it is desired to extract the sample materials from the collection housing 134 (e.g. the end 182 is over a sample container), the motor 106 is operated to rotate the lead screw 108 to move the auger assembly 116 axially in the direction indicated by arrow 211. As the auger assembly 116 moves, the contact of the end 196 with the mount housing 120 causes the rotation of the first link 192. This in turn moves the second link 200 causing the third link 202 to rotate and move the end 208 towards the thrust plate 210. At a predetermined point in the travel of the auger assembly 116, the end 208 contacts the thrust plate 210 with sufficient force to overcome the preload from spring 154 and move the drill shaft 146 to engage the dog clutch 158. As discussed above the engagement of the dog clutch 158 generates a percussion impact. When this occurs while also rotating the motor 118 in reverse, the sample material will be ejected through the entrance opening 168 into the sample container or the analysis apparatus. It was found that the combination of the percussive shocks with the reverse spin of the auger provided improved performance in dropping sample material from the collection housing 134. This embodiment provides advantages in allowing for engagement of the dog clutch and generating of the percussive force without applying a load to the auger bit. This reduces the wear on the auger bit.

In an embodiment, the drill assembly 100 may include two linkage assemblies 190 arranged on opposite sides of the auger assembly 116.

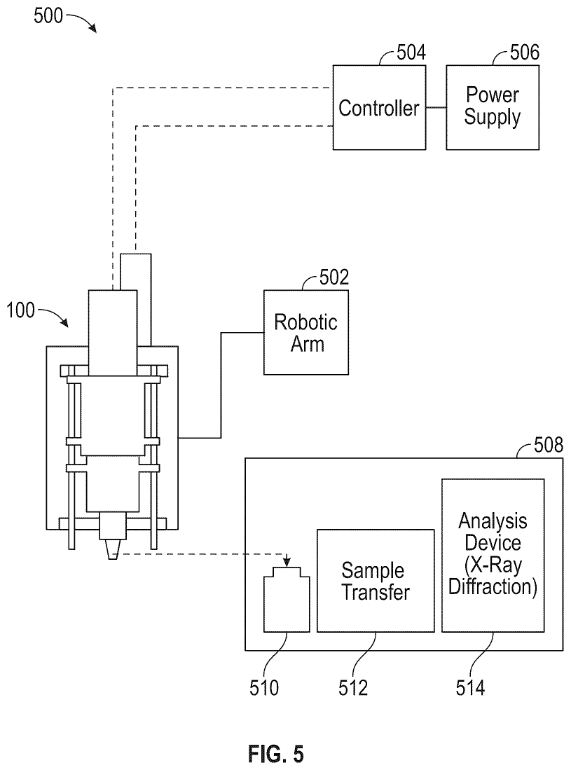

Referring now to FIG. 5 and embodiment is shown of a system 500 for collecting and analyzing samples, such as on extraterrestrial environments for example. In this embodiment, the drill assembly 100 is coupled to a movement device, such as a robotic arm 502 for example. The movement device may be coupled to a vehicle (not shown) or an autonomous/semi-autonomous rover that transports the drill assembly 100 to the location where samples are desired. The movement device is configured to move the drill assembly 100 between two or more positions, such in a stored position, a drilling operation position, and a sample recovery position for example.

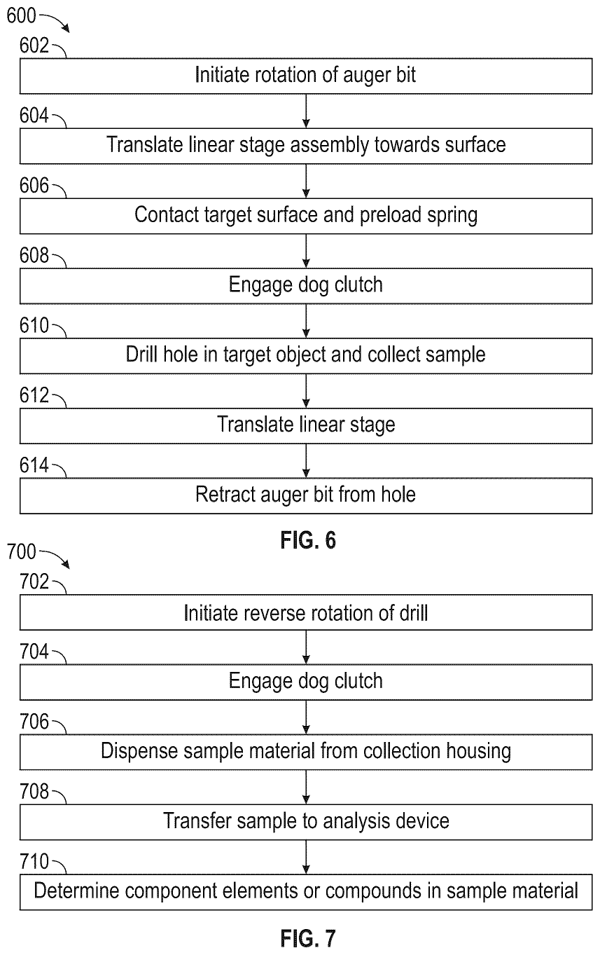

The drill assembly 100 is also coupled to a controller 504 and a power supply 506. The controller 504 provides operational signals and controls the flow of electrical power to the drill assembly 100, such as to operate the motors 106, 118 for example. The controller 504 may perform, or cause to perform, one or more steps in the methods described with respect to FIG. 6 and FIG. 7.

The system 500 further includes an analysis system 508 that is operably coupled to the drill assembly 100. The analysis system 508 may include a sample container 510 that is configured to receive the sample material from the collection housing 134. The analysis system 508 may further include a sample transfer device 512 that moves the sample material from the sample container 510 to the analysis device 514. In the example embodiment, the analysis device 514 is an X-ray diffraction device that allows for determining the composition and elements making up the sample material.

Referring now to FIG. 6, a method 600 is shown for obtaining a sample from an environment, such as an extraterrestrial environment for example. The method 600 begins in block 602 where rotation of the auger bit 152 is initiated. In some embodiments, block 602 may be optional. Starting rotation of the auger bit 152 reduces the risk of the motor 118 stalling when the auger bit contacts the surface being drilled. However, in some embodiments, it may be desirable to initially contact the surface with an auger bit not spinning to test the surface. The method 600 then proceeds to block 604 where the linear stage 102 is activated to move the auger assembly 116 towards the surface in the environment where it is desired to collect a sample.

In block 606, the target surface is contacted with the tip of the auger bit 152, depending on the hardness of the surface, this will cause a compression of the compression spring 154. Once the drill shaft 146 moves the distance “d”, the rotating portion 160 and the stationary portion 162 of the dog clutch 158 will engage generate the percussive impact in block 608. As the percussive action is occurring, the method 600 proceeds to block 610 where the linear stage 102 advances the auger bit 152 into the target surface. As the auger bit 152 advances, a piling of dust material will form around the auger bit between the target surface and the end 182 of the collection housing 134. As the auger bit 152 continues to advance, sample material that collects in the flutes of the auger bit 152 will be forced along the flutes and into the interior space 170 of the collection housing 134. Due to centripetal loading, the sample material will be moved from the flutes into the interior space 170.

It should be appreciated that in some embodiment the target surface or the target object may not have sufficient hardness to compress the compression spring 154. For example, the target object may be comprised of sand or other granular material. It has been found that the collection of sample material may occur in these types of embodiments without engaging the dog clutch or generating a percussion impact.

Once the auger bit 152 has reached a desired depth, the linear stage 102 is activated in block 612 to move the auger assembly 116 in a direction away from the target surface. The method 600 ends in block 614 where the auger bit is retracted from the hole formed during the drilling operation.

Referring now to FIG. 7, a method 700 is shown for dispensing and analyzing the sample material. The method 700 begins in block 702 where the rotational of the motor 118 is initiated in a direction (e.g. counter-clockwise) that is opposite of the drilling direction (e.g. clockwise). In an embodiment, the rotation of the motor during dispensing operations is slower than a drilling operation. The method 700 then proceeds to block 704 where the dog clutch 158 is engaged to generate a percussion impact. It has been found that combining the reverse drill direction (e.g. counter-clockwise) with the percussion impact provides advantages in dispensing sample material from the collection housing 134.

In an embodiment, the drill assembly 100 includes the linkage assembly 190. In this embodiment, the linear stage 102 is activated to move the auger assembly 116 to the second position (FIG. 4B) to engage the linkage assembly 190 with the thrust plate 210 and cause the dog clutch 158 to engage. In another embodiment, the linear stage 102 is moved towards and contacts a collection surface (e.g. an inner surface of a sample container). This causes the auger bit 152 to move the drill shaft 146 to engage the dog clutch 158 and generate the percussion impact.

In some embodiments, the actions of block 702 and block 704 occur simultaneously.

The method 700 then proceeds to block 706 where the sample material is dispensed from the collection housing 134 onto or into another surface external to the drill assembly 100, such as a sample container or directly into a sample receptacle in an analysis device 514. Where the sample material is dispensed into a sample container 510, the sample container may be transferred to the analysis device 514 in block 708. Finally, the method proceeds to block 710 where the component elements or compounds that comprise the sample material are determined. In the example embodiment, the analysis device 514 is an X-ray diffraction device. An X-ray diffraction analysis is a nondestructive technique that provides information about the chemical composition of a material. The analysis method uses constructive interference of monochromatic X-rays and a powdered sample. The X-rays are collimated and directed to the powdered sample. The X-rays interact with the sample to produce a diffracted ray. This diffracted ray is then detected and counted. The intensity of the diffracted rays identifies the composition of the sample material.

It should be appreciated that while one powder funnel geometry is disclosed herein, the claims should not be so limited. It is contemplated that different powder funnel geometries may be utilized to better collect material from natural surfaces and at odd angles. Additionally, in other embodiments an auger or bit change system or different bit/auger cutter materials may be utilized to extend the lifetime capability of the drill. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A drill comprising:
a translation mechanism; and
an auger mechanism movably coupled to the translation mechanism, the drill mechanism having a housing with an auger bit slidably disposed therein, the auger mechanism further having a collection housing coupled to one end, the auger bit being configured to extend through the collection housing during operation, the collection housing having a hollow interior.

2. The drill of claim 1, wherein the collection housing is configured to receive material from the auger bit during operation.

3. The drill of claim 2, wherein the collection housing has a conical portion.

4. The drill of claim 1, wherein the auger bit is removably coupled to a drill shaft that is slidably coupled to a motor.

5. The drill of claim 4, further comprising a first biasing member operably coupled between the housing and the drill shaft to bias the auger to extend outward from the collection housing.

6. The drill of claim 5, further comprising a hammer assembly operably coupled between the housing and the motor, the hammer assembly configured to selectively oscillate the auger bit during operation.

7. The drill of claim 6, wherein the hammer assembly comprises:
a dog clutch having a first member coupled to the drill shaft and a second member operably coupled to the housing, the first member and second member being selectively coupled in response to axial translation of the auger bit; and
a second biasing member operably coupled to the second member, the second biasing member cooperating with the first biasing member to oscillate the auger bit in response to the first member engaging the second member.

8. The drill of claim 7, wherein the second biasing member is a plurality of Belville Springs.

9. The drill of claim 8, wherein the first biasing member is a compression spring.

10. The drill of claim 1, wherein the translation mechanism comprises a frame, a lead screw rotationally coupled to the frame, and a second motor operably coupled to the lead screw.

11. The drill of claim 10, wherein the drill mechanism includes a lead nut coupled to the lead screw, the lead nut causing the drill mechanism to translate in response to rotation of the lead screw.

12. The drill of claim 11, wherein the translation mechanism includes at least one slide member fixedly coupled to the frame, the housing being slidably coupled to the slide member.

13. A system comprising:
a sample collection device having a sample container;
a drill device having a translation mechanism and an auger mechanism movably coupled to the translation mechanism, the auger mechanism having a housing with an auger bit slidably disposed therein, the auger mechanism further having a collection housing coupled to one end, the auger bit being configured to extend through the collection housing during operation, the collection housing having a hollow interior; and
a controller operably coupled to the sample collection device and the drill device.

14. The system of claim 13, wherein the controller is operable to selectively actuate the translation mechanism to translate the auger mechanism.

15. The system of claim 14, wherein the controller is operably to selectively actuate the auger mechanism to rotate the auger bit in a first direction prior to the auger bit contacting a target surface.

16. The system of claim 15, wherein the auger mechanism is configured to oscillate the auger bit in response to the translation mechanism generating a predetermined amount of preload on the auger bit.

17. The system of claim 16, wherein the controller is further operable to cause the translation mechanism to translate the auger bit away from a target surface and transfer sample material from the collection housing to the sample container.

18. The system of claim 17, wherein the transferring of sample material from the collection housing to the sample container includes the controller causing the auger bit to rotate in a second direction when the auger bit is positioned in the sample container, the second direction being opposite the first direction.

19. A method of collecting and analyzing a sample comprising:
providing a drilling assembly having a linear stage and an auger mechanism;
initiating rotation in a first direction of an auger bit in the auger mechanism;
moving the linear stage to cause the auger bit to moving in a direction towards a target surface on a target object;
engaging the auger bit with the target surface;
causing a percussion impact with the auger mechanism in respect to the auger bit engaging the target surface;
causing material from the target object to enter a flute on the auger bit and move into a collection housing on the auger mechanism; and
causing the material to move from the flute into a space within the collection housing.

20. The method of claim 19, further comprising;
moving the linear stage to remove the auger bit from a hole;
rotating the auger bit in a second direction, the second direction being opposite the first direction;
causing a percussion impact with the auger mechanism; and
dispensing sample material from the collection housing.
